(19) United States
(12) Patent Application Publication
(10) Pub. No.: US 2008/0108326 A1
(43) Pub. Date: May 8, 2008

(54) Handover method in a wireless communication system

(75) Inventors: Young-Jun Park, Seoul (KR); Kug Shin, Seoul (KR); Min-Young Ahn, Seongnam-si (KR); Se-Youn Lim, Seoul (KR)

Correspondence Address: DOCKET CLERK, P.O. DRAWER 800889, DALLAS, TX, 75380, US

(73) Assignee: SAMSUNG ELECTRONICS CO., LTD., Suwon-si (KR)

(21) Appl. No.: 11/983,104

(22) Filed: Nov. 7, 2007

(30) Foreign Application Priority Data
Nov. 7, 2006 (KR) 2006-109623
Aug. 3, 2007 (KR) 2007-77941

(51) Int. Cl. H04M 1/66; H04Q 7/22

(52) U.S. Cl. 455/411; 455/412.2; 455/437

(57) ABSTRACT

A handover method in a wireless communication system is provided, in which upon receipt of a handover request message requesting a handover from a mobile station, a serving base station transmits a handover notify message to a target base station indicated by the handover request message, receives a handover notify ACK message from the target base station, determines from the handover notify ACK message whether the target base station has accepted the handover of the mobile station, generates a handover response message indicating whether the handover of the mobile station has been accepted, transmits the handover response message to the mobile station, and terminates communications with the mobile station, upon receipt of a handover complete message from the target base station.

### CROSS-REFERENCE TO RELATED PATENT APPLICATION AND CLAIM OF PRIORITY

This application claims priority under 35 U.S.C. §119(a) to a Korean Patent Application filed in the Korean Intellectual Property Office on Nov. 7, 2006 and assigned Serial No. 2006-109623 and a Korean Patent Application filed in the Korean Intellectual Property Office on Aug. 3, 2007 and assigned Serial No. 2007-77941, the entire disclosure of both of which is hereby incorporated herein by reference.

### TECHNICAL FIELD OF THE INVENTION

The present invention relates generally to a wireless communication system. More particularly, the present invention relates to a handover method in a multi-hop wireless communication system.

### BACKGROUND OF THE INVENTION

Wireless communication systems are under development that will provide high-speed data transmission and reception, ensuring mobility to mobile stations. They will also provide services with various Quality of Service (QoS) requirements.

Among the wireless communication systems, a wireless communication system adopting a multi-hop relay data transmission scheme through relay stations is under consideration. The use of relay stations expands the coverage of base stations and improves throughput. In a particular area under a poor channel environment, installation of a relay station leads to a throughput increase. When the relay station is positioned near a cell boundary, it enables a mobile station beyond the coverage area of a base station to communicate with the base station.

Aside from high data rate, another significant factor that increases performance in the wireless communication system is seamless handover. Handover is the process of continuing an ongoing service to a mobile station while the mobile station is moving from one base station to another base station. As the quality of a service from the serving base station decreases, the mobile station moves to the target base station to receive the service with better quality. This is possible by handover.

A gateway base station controller (BSC), also called a mobile switching center (MSC) or an access control router (ACR), manages handover in a non-relay wireless communication system. For a relay wireless communication system, a 1-tier access network is considered and thus a 1-tier handover scheme requiring interaction between a serving base station and a target base station is considered. If a base station is responsible for deciding whether a handover is required in the relay wireless communication system, system complexity increases and multi-hop relaying gets less flexible. Accordingly, there exists a need for a procedure in which a mobile station decides as to whether a handover is required and initiates the handover in the relay wireless communication system.

### SUMMARY OF THE INVENTION

To address the above-discussed deficiencies of the prior art, it is a primary aspect of exemplary embodiments of the present invention to address at least the problems and/or disadvantages and to provide at least the advantages described below. Accordingly, an aspect of exemplary embodiments of the present invention is to provide a method for supporting handover in a multi-hop wireless communication system.

Another aspect of exemplary embodiments of the present invention provides a method for supporting handover between a base station (BS) and a relay station (RS) in a multi-hop wireless communication system.

In accordance with an aspect of exemplary embodiments of the present invention, there is provided a handover method of a serving base station in a multi-hop wireless communication system, in which upon receipt of a handover request message requesting a handover from a mobile station, a handover notify message is transmitted to a target base station indicated by the handover request message, a handover notify ACK message is received from the target base station, it is determined from the handover notify ACK message whether the target base station has accepted the handover of the mobile station, a handover response message indicating whether the handover of the mobile station has been accepted is generated and transmitted to the mobile station, and upon receipt of a handover complete message from the target base station, communications with the mobile station are terminated.

In accordance with another aspect of exemplary embodiments of the present invention, there is provided a handover method of a target base station in a multi-hop wireless communication system, in which a handover notify message indicating a mobile station will perform a handover is received from a serving base station, it is determined whether a target base station identifier (BS ID) is set to an identifier (ID) of the target base station in the handover notify message, it is determined whether to accept the mobile station, if the target BS ID is set to the ID of the target base station in the handover notify message, it is determined whether a target relay station (RS ID) indicates a relay station (RS) under the target base station, if it is determined to accept the mobile station, the handover notify message is transmitted to the relay station by tunneling, if the target RS ID indicates a relay station under the target base station, a handover indication message indicating that the mobile station will perform the handover is received from the mobile station, and a handover complete message is transmitted to the serving base station by tunneling.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates the configuration of a multi-hop wireless communication system according to the present invention;

FIGS. 2A to 2I illustrate the formats of messages used for a handover in the multi-hop wireless communication system according to an exemplary embodiment of the present invention;

FIG. 3 is a diagram illustrating a signal flow for a handover from BS1 to BS2 in the multi-hop wireless communication system according to an exemplary embodiment of the present invention;

FIG. 4 is a diagram illustrating a signal flow for a handover from BS1 to an RS within a neighbor cell in the multi-hop wireless communication system according to an exemplary embodiment of the present invention;

FIG. 5 is a diagram illustrating a signal flow for a handover from an RS to BS1 in the multi-hop wireless communication system according to an exemplary embodiment of the present invention;

FIG. 6 is a diagram illustrating a signal flow for a handover from BS2 to an RS in the multi-hop wireless communication system according to an exemplary embodiment of the present invention;

FIG. 7 is a diagram illustrating a signal flow for a handover from an RS to BS2 in the multi-hop wireless communication system according to an exemplary embodiment of the present invention;

FIG. 8 is a block diagram of a BS in the multi-hop wireless communication system according to an exemplary embodiment of the present invention;

FIG. 9 is a flowchart of an operation of the BS when the BS receives a HandOver-REQuest (HO-REQ) message in the multi-hop wireless communication system according to an exemplary embodiment of the present invention;

FIG. 10 is a flowchart of an operation of the BS when the BS receives a HandOver-NOTIFY (HO-NOTIFY) message in the multi-hop wireless communication system according to an exemplary embodiment of the present invention;

FIG. 11 is a flowchart of an operation of the BS when the BS receives a HandOver-NOTIFY-ACKnowledgment (HO-NOTIFY-ACK) message in the multi-hop wireless communication system according to an exemplary embodiment of the present invention;

FIG. 12 is a flowchart of an operation of the BS when the BS receives a HandOver-INDication (HO-IND) message in the multi-hop wireless communication system according to an exemplary embodiment of the present invention; and

FIG. 13 is a flowchart of an operation of the BS when the BS receives a HandOver-COMPLETE (HO-COMPLETE) message in the multi-hop wireless communication system according to an exemplary embodiment of the present invention.

Throughout the drawings, the same drawing reference numerals will be understood to refer to the same elements, features and structures.

### DETAILED DESCRIPTION OF THE INVENTION

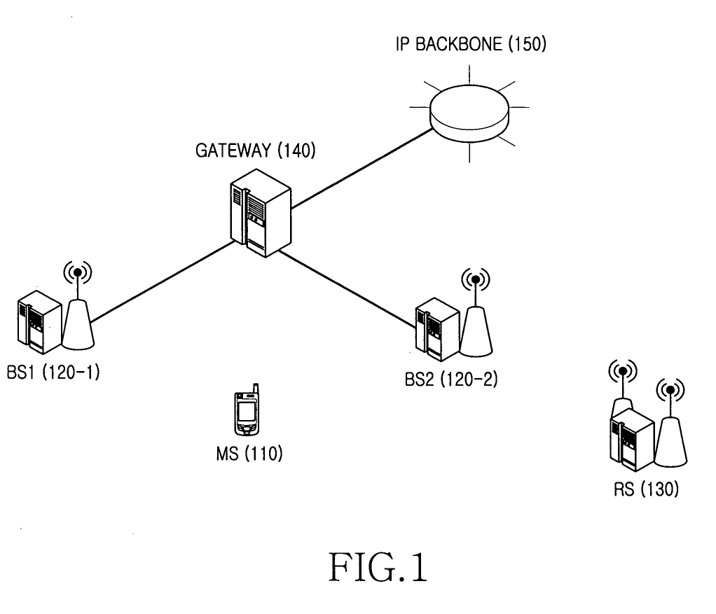

FIGS. 1 through 13, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

Exemplary embodiments of the present invention provide a handover method in a multi-hop wireless communication system.

FIG. 1 illustrates the configuration of a multi-hop wireless communication system according to the present invention.

Referring to FIG. 1, the multi-hop wireless communication system includes a mobile station (MS) 110, first and second base stations 120-1 and 120-2 (also called BS1 and BS2), a gateway 140, and an Internet Protocol (IP) backbone 150. The MS 110 is an end entity that provides a service directly to a user. It communicates with BS1 and BS2 via a radio interface.

BS1 and BS2(120-1, 120-2) are entities that communicate with the MS 110 via radio interfaces and provide Layer 2 (L2) connectivity to the MS 110. BS1 and BS2 access a wired network via the gateway 140.

BS1 has no lower relay stations (RSs), whereas BS2 has a lower relay station (RS) 130. Thus, BS2 can transmit traffic to the MS 110 in two modes. One of the two modes is a Direct Transmission (DT) Mode and the other mode is a Decode and Forward (DF) mode. BS2 transmits traffic directly to the MS 110 via its radio interface in the DT mode. In the DF mode, BS2 transmits traffic to the RS 130 and controls the RS 130 to relay the traffic to the MS 110.

The RS 130 is an entity that provides L2 connectivity to the MS 110 like BS1 and BS2. The RS 130 accesses the wired network via radio interfaces between the RS 130 and BS1 and BS2. The radio interface between the MS 110 and the RS 130 may be the same as or different from those between the RS 130 and BS1 and BS2.

The gateway 140 provides wired network connectivity to BS1 and BS2 and is responsible for traffic transmission between a wireless access network and the wired network. The IP backbone 150 is an entity that is connected to gateways 140 and directly accesses an IP network.

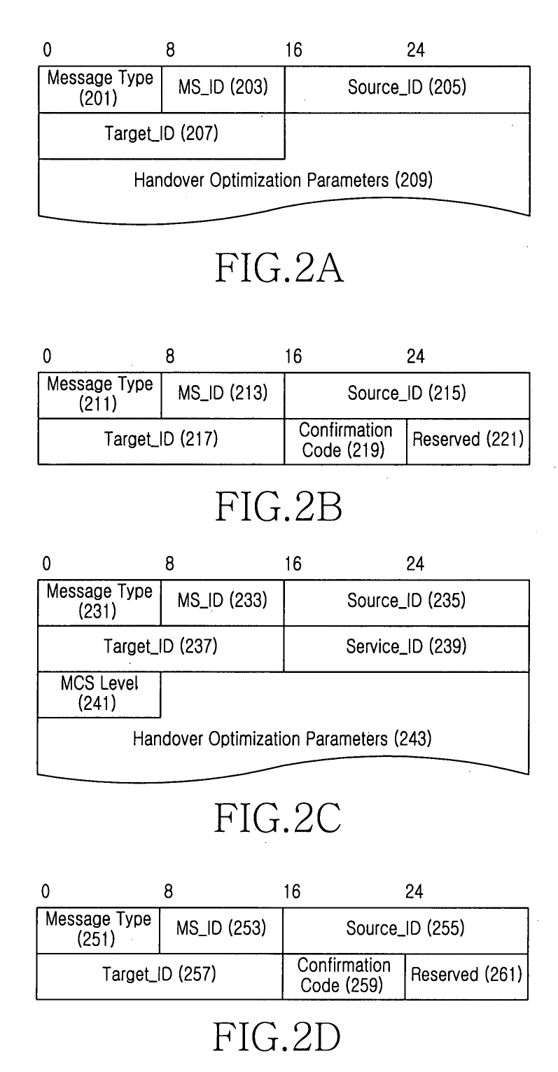

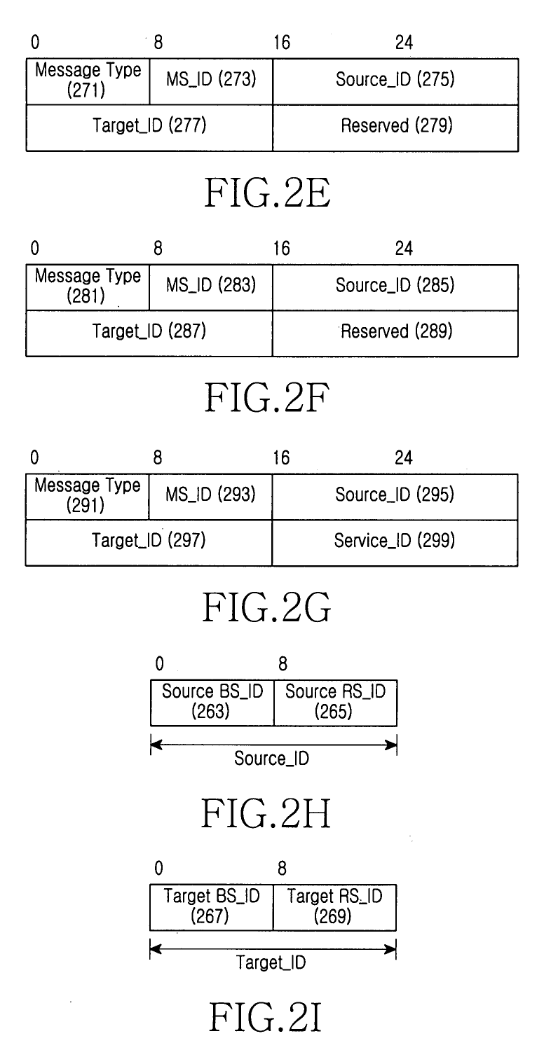

In the system having the configuration illustrated in FIG. 1, the MS performs handover between BSs and between a BS and an RS. Exemplary formats of control messages and Identifiers (IDs) used between entities during a handover will be described below with reference to FIGS. 2A to 2I.

FIG. 2A illustrates the format of an HO-REQ message in the multi-hop wireless communication system according to the present invention.

Referring to FIG. 2A, the HO-REQ message includes Message Type 201, MS_ID 203, Source_ID 205, Target_ID 207, and Handover Optimization Parameters 209 that is an additional information field directed from an MS to a BS for a handover.

Message Type 201 indicates that this message is an HO-REQ message. It is set to ‘0x1’. MS_ID 203 provides an ID of the MS. Source_ID 205 has an ID of a serving node to which the MS is currently connected. Target_ID 207 indicates an ID of a target BS to which the MS intends to move by handover. If Message Type 201 is set to ‘0x0’, this implies that the MS has not chosen a target BS yet.

FIG. 2B illustrates the format of a HandOver-ReSPonse (HO-RSP) message in the multi-hop wireless communication system according to the present invention.

Referring to FIG. 2B, the HO-RSP message includes Message Type 211, MS_ID 213, Source_ID 215, Target_ID 217, Confirmation Code 219, and Reserved 221.

Message Type 211 indicates that this message is an HO-RSP message. It is set to ‘0x2’. MS_ID 213 provides the ID of the MS. Source_ID 215 has the ID of the serving node to which the MS is currently connected. Target_ID 217 indicates the ID of the target BS to which the MS intends to move by handover. Confirmation Code 219 indicates whether the handover request has been accepted or rejected. For acceptance, Confirmation Code 219 is set to ‘0x1’ and for rejection, it is set to ‘0x0’.

FIG. 2C illustrates the format of an HO-NOTIFY message in the multi-hop wireless communication system according to the present invention.

Referring to FIG. 2C, the HO-NOTIFY message includes Message Type 231, MS_ID 233, Source_ID 235, Target_ID 237, Service_ID 239, MCS Level 241, and Handover Optimization Parameters 243 that is an additional information field directed from the MS to the BS for the handover.

Message Type 231 indicates that this message is an HO-NOTIFY message. It is set to ‘0x3’. MS_ID 233 provides the ID of the MS. Source_ID 235 has the ID of the serving node to which the MS is currently connected. Target_ID 237 indicates the ID of the target BS to which the MS intends to move by handover. Service_ID 239 is an ID of a service that the MS is receiving from the gateway. MCS Level 241 indicates a Modulation and Coding Scheme (MCS) in current use for the MS.

FIG. 2D illustrates the format of an HO-NOTIFY-ACK message in the multi-hop wireless communication system according to the present invention.

Referring to FIG. 2D, the HO-NOTIFY-ACK message includes Message Type 251, MS_ID 253, Source_ID 255, Target_ID 257, Confirmation Code 259, and Reserved 261.

Message Type 251 indicates that this message is an HO-NOTIFY-ACK message. It is set to ‘0x4’. MS_ID 253 provides the ID of the MS. Source_ID 255 has the ID of the target node to which the MS intends to move by handover. Target_ID 257 indicates the ID of the serving node to which the MS is currently connected. Confirmation Code 259 indicates whether the new MS has been accepted by handover. For acceptance, Confirmation code 259 is set to ‘0x1’ and for rejection, it is set to ‘0x0’.

FIG. 2E illustrates the format of an HO-IND message in the multi-hop wireless communication system according to the present invention.

Referring to FIG. 2E, the HO-IND message includes Message Type 271, MS_ID 273, Source_ID 275, Target_ID 277, and Reserved 279.

Message Type 271 indicates that this message is an HO-IND message. It is set to ‘0x5’. MS_ID 273 provides the ID of the MS. Source_ID 275 has the ID of the serving node to which the MS is currently connected. Target_ID 277 indicates the ID of the target node to which the MS intends to move by handover.

FIG. 2F illustrates the format of an HO-COMPLETE message in the multi-hop wireless communication system according to the present invention.

Referring to FIG. 2F, the HO-COMPLETE message includes Message Type 281, MS_ID 283, Source_ID 285, Target_ID 287, and Reserved 289.

Message Type 281 indicates that this message is an HO-COMPLETE message. It is set to ‘0x6’. MS_ID 283 provides the ID of the MS. Source_ID 285 has the ID of the target node to which the MS intends to move by handover. Target_ID 287 indicates the ID of the serving node to which the MS is currently connected.

FIG. 2G illustrates the format of a HandOver-REPORT (HO-REPORT) message in the multi-hop wireless communication system according to the present invention.

Referring to FIG. 2G, the HO-REPORT message includes Message Type 291, MS_ID 293, Source_ID 295, Target_ID 297, and Service_ID 299.

Message Type 291 indicates that this message is an HO-REPORT message. It is set to ‘0x7’. MS_ID 293 provides the ID of the MS. Source_ID 295 has the ID of the serving node to which the MS is currently connected. Target_ID 297 indicates the ID of the target node to which the MS intends to move by handover. Service_ID 299 provides the ID of the service that the MS is receiving from the gateway.

FIG. 2H illustrates the format of a serving node ID in the multi-hop wireless communication system according to the present invention.

Referring to FIG. 2H, the serving node ID includes Source BS_ID 263 and Source RS_ID 265. Source BS_ID 263 provides a BS ID and Source RS_ID 265 provides an RS ID. In other words, the serving node ID is a combination of the RS ID and the BS ID. For example, if the serving node is an RS, the serving node ID is a combination of an ID of the RS and an ID of an upper BS that controls the RS. If the serving node is a BS, the serving node ID includes an ID of the BS and Source RS_ID set to ‘0x0’.

FIG. 2I illustrates the format of a target node ID in the multi-hop wireless communication system according to the present invention.

Referring to FIG. 2I, the target node ID includes Target BS_ID 267 and Target RS_ID 269. Target BS_ID 267 provides a BS ID and Target RS_ID 269 provides an RS ID. In other words, the target node ID is a combination of the RS ID and the BS ID. For example, if the target node is an RS, the target node ID is a combination of an ID of the RS and an ID of an upper BS that controls the RS. If the target node is a BS, the serving node ID includes an ID of the BS and Target RS_ID set to ‘0x0’.

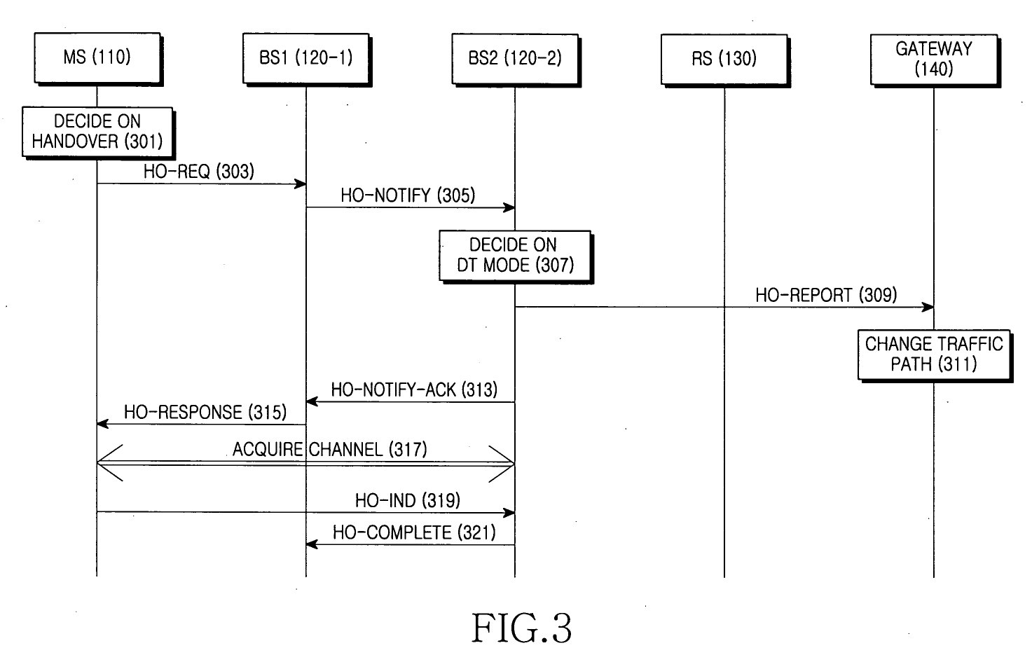

FIG. 3 is a diagram illustrating a signal flow for a handover from BS1 to BS2 in the multi-hop wireless communication system according to the present invention.

Referring to FIG. 3, upon detection that the channel status between the MS 110 and BS1 becomes poor, the MS 110 determines to perform a handover in step 301 and transmits an HO-REQ message to BS1 in step 303. The HO-REQ message has an ID of BS2 set in Target_ID.

Upon receipt of the HO-REQ message, BS1 transmits an HO-NOTIFY message to BS2 in step 305. As BS2 detects its ID in Target_ID of the HO-NOTIFY message, it decides to support DT mode to the MS 110 in step 307.

In step 309, BS2 transmits an HO-REPORT message to the gateway 140. The gateway 140 determines from the HO-REPORT message that the MS 110 will perform a handover and thus changes a downlink traffic path for the MS 110 in step 311.

BS2 transmits an HO-NOTIFY-ACK message to BS1 in step 313. BS1 then transmits an HO-RSP message to the MS 110 in step 315.

Determining from the HO-RSP message that the handover has been accepted, the MS 110 acquires a radio channel with BS2 in step 317. In step 319, the MS 110 transmits an HO-IND message to BS2. Upon receipt of the HO-IND message, BS2 transmits an HO-COMPLETE message to BS1 in step 321.

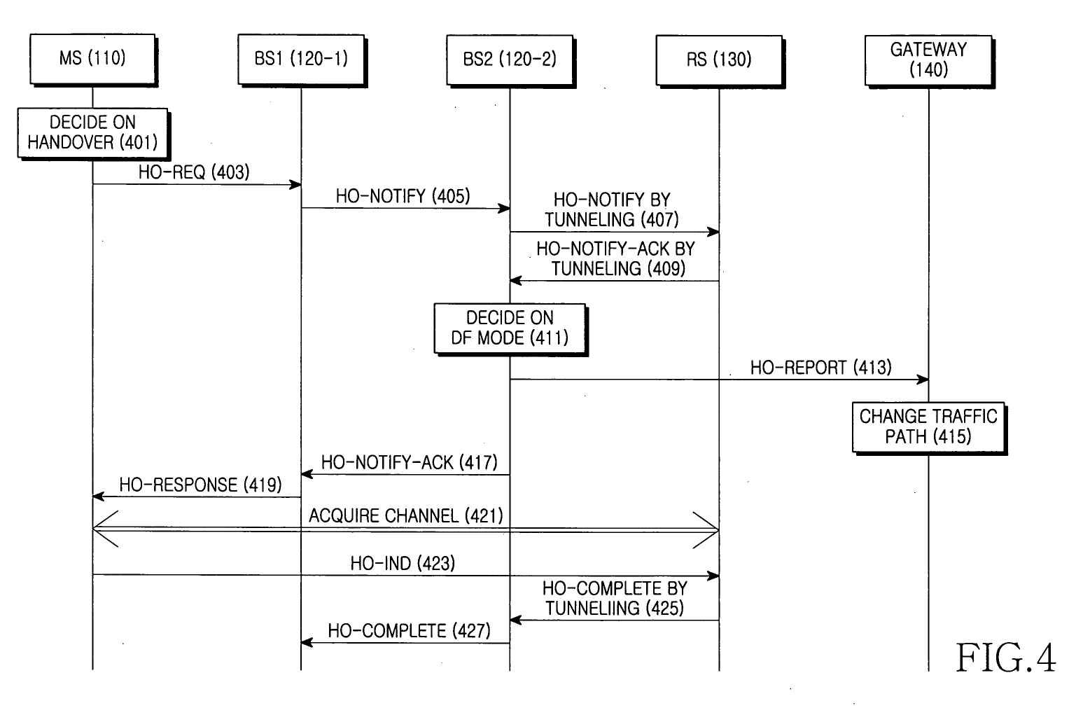

FIG. 4 is a diagram illustrating a signal flow for a handover from BS1 to the RS 130 within a neighbor cell in the multi-hop wireless communication system according to the present invention.

Referring to FIG. 4, upon detection that the channel status between the MS 110 and BS1 becomes poor, the MS 110 determines to perform a handover in step 401 and transmits an HO-REQ message to BS1 in step 403. The HO-REQ message has an ID of the RS 130 set in Target_ID.

Upon receipt of the HO-REQ message, BS1 transmits an HO-NOTIFY message to BS2 in step 405. As BS2 detects the ID of the RS 130 in Target_ID of the HO-NOTIFY message, it transmits the HO-NOTIFY message to the RS 130 by tunneling in step 407.

In step 409, the RS 130 transmits an HO-NOTIFY-ACK message to BS2 by tunneling. BS2 thus decides to support DF mode to the MS 110 in step 411 and transmits an HO-REPORT message to the gateway 140 in step 413.

The gateway 140 determines from the HO-REPORT message that the MS 110 will perform a handover and thus changes a downlink traffic path for the MS 110 in step 415.

BS2 transmits the HO-NOTIFY-ACK message to BS1 in step 417. BS1 then transmits an HO-RSP message to the MS 110 in step 419.

Determining from the HO-RSP message that the handover has been accepted, the MS 110 acquires a radio channel with the RS 130 in step 421. In step 423, the MS 110 transmits an HO-IND message to the RS 130.

Upon receipt of the HO-IND message, the RS 130 transmits an HO-COMPLETE message to BS2 by tunneling in step 425 and BS2 transmits the HO-COMPLETE message to BS1 in step 427.

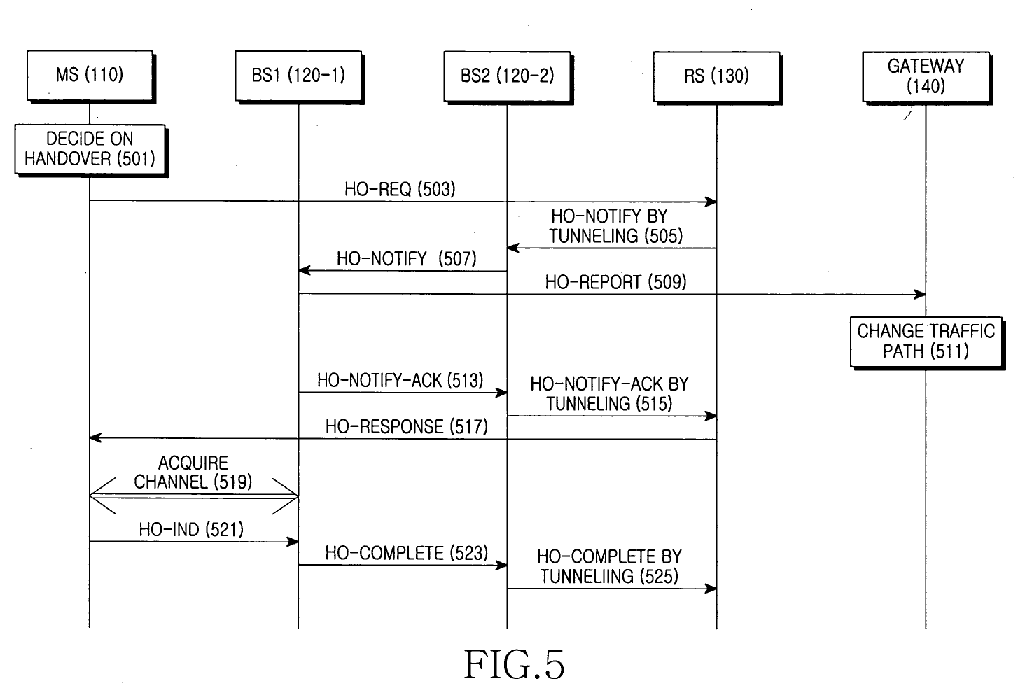

FIG. 5 is a diagram illustrating a signal flow for a handover from the RS 130 to BS1 in the multi-hop wireless communication system according to the present invention.

Referring to FIG. 5, upon detection that the channel status between the MS 110 and the RS 130 becomes poor, the MS 110 determines to perform a handover in step 501 and transmits an HO-REQ message to the RS 130 in step 503. The HO-REQ message has the ID of BS1 set in Target_ID.

Upon receipt of the HO-REQ message, the RS 130 transmits an HO-NOTIFY message to BS2 by tunneling in step 505. As BS2 detects the ID of BS1 in Target_ID of the HO-NOTIFY message, it transmits the HO-NOTIFY message to BS1 in step 507.

Instep 509, BS1 transmits an HO-REPORT message to the gateway 140. The gateway 140 determines from the HO-REPORT message that the MS 110 will perform a handover and thus changes a downlink traffic path for the MS 110 in step 511.

BS1 transmits an HO-NOTIFY-ACK message to BS2 in step 513. BS2 then transmits the HO-NOTIFY-ACK message to the RS 130 by tunneling in step 515.

Upon receipt of the HO-NOTIFY-ACK message, the RS 130 transmits an HO-RSP message to the MS 110 in step 517. Determining from the HO-RSP message that the handover has been accepted, the MS 110 acquires a radio channel with BS1 in step 519.

In step 521, the MS 110 transmits an HO-IND message to BS1. Upon receipt of the HO-IND message, BS1 transmits an HO-COMPLETE message to BS2 in step 523 and BS2 transmits the HO-COMPLETE message to the RS 130 by tunneling in step 525.

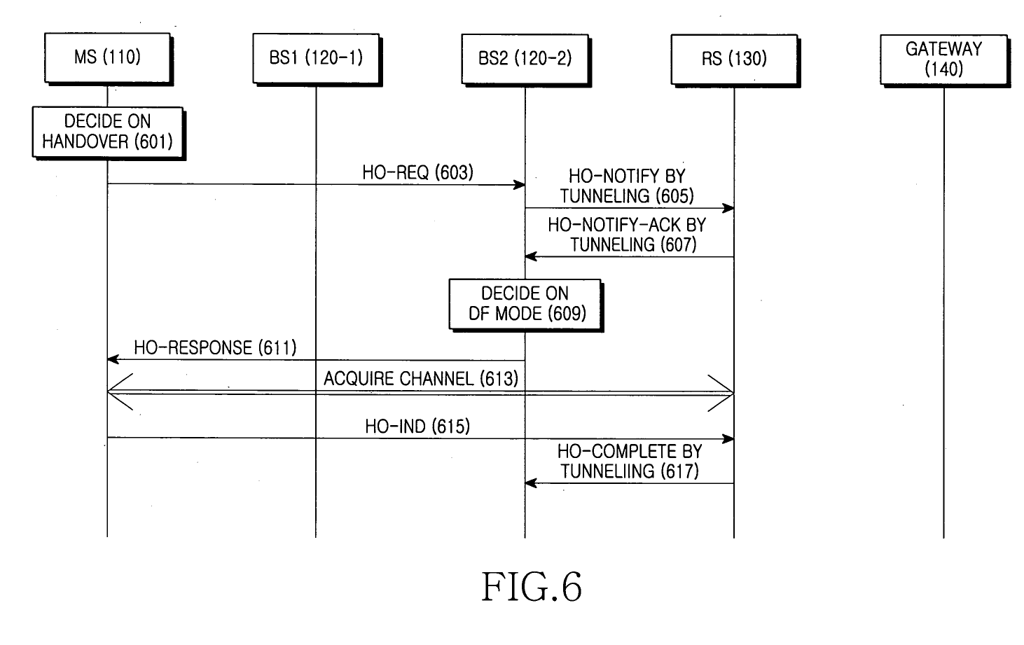

FIG. 6 is a diagram illustrating a signal flow for a handover from BS2 to the RS 130 in the multi-hop wireless communication system according to the present invention.

Referring to FIG. 6, upon detection that the channel status between the MS 110 and BS2 becomes poor, the MS 110 determines to perform a handover in step 601 and transmits an HO-REQ message to BS2 in step 603. The HO-REQ message has the ID of the RS 130 set in Target_ID.

Upon receipt of the HO-REQ message, BS2 transmits an HO-NOTIFY message to the RS 130 by tunneling in step 605. As the RS 130 detects its ID in Target_ID of the HO-NOTIFY message, it transmits an HO-NOTIFY-ACK message to BS2 in step 607.

In step 609, BS2 determines to support DF mode to the MS 110. Then, BS2 transmits an HO-RSP message to the MS 110 in step 611.

Determining from the HO-RSP message that the handover has been accepted, the MS 110 acquires a radio channel with the RS 130 in step 613. In step 615, the MS 110 transmits an HO-IND message to the RS 130. Upon receipt of the HO-IND message, the RS 130 transmits an HO-COMPLETE message to BS2 by tunneling in step 617.

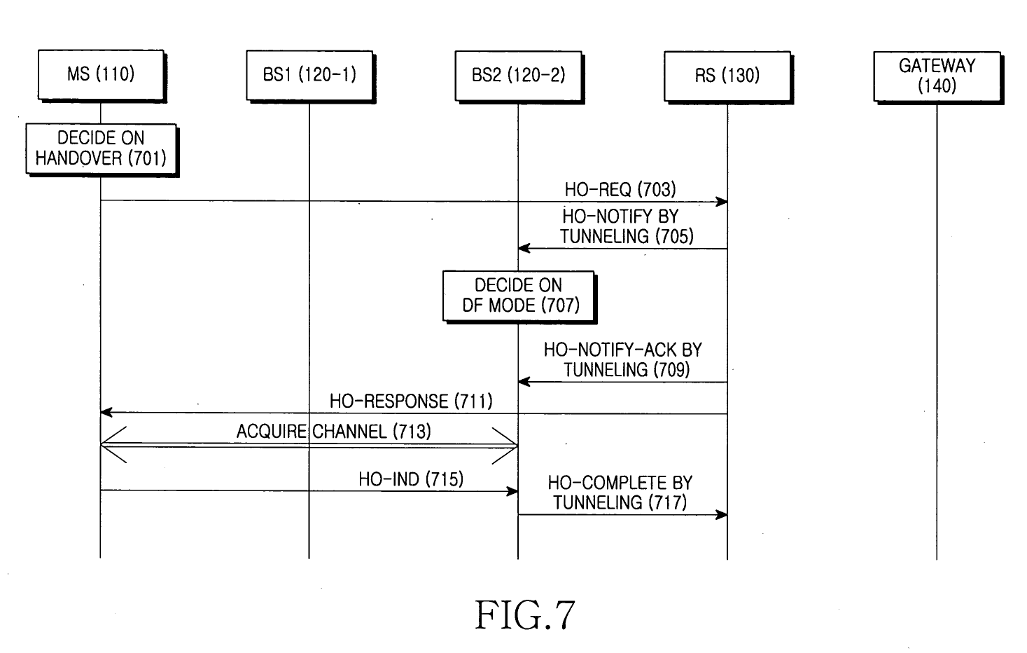

FIG. 7 is a diagram illustrating a signal flow for a handover from the RS 130 to BS2 in the multi-hop wireless communication system according to the present invention.

Referring to FIG. 7, upon detection that the channel status between the MS 110 and the RS 130 becomes poor, the MS 110 determines to perform a handover in step 701 and transmits an HO-REQ message to the RS 130 in step 703. The HO-REQ message has the ID of BS2 set in Target_ID.

Upon receipt of the HO-REQ message, the RS 130 transmits an HO-NOTIFY message to BS2 by tunneling in step 705. In step 707, upon receipt of the HO-NOTIFY message, BS2 decides to support DT mode to the MS 110. As BS2 detects its ID in Target_ID of the HO-NOTIFY message, it transmits an HO-NOTIFY-ACK message to the RS 130 in step 709.

In step 711, the RS 130 transmits an HO-RSP message to the MS 110. Determining from the HO-RSP message that the handover has been accepted, the MS 110 acquires a radio channel with BS2 in step 713.

In step 715, the MS 110 transmits an HO-IND message to BS2. Upon receipt of the HO-IND message, BS2 transmits an HO-COMPLETE message to the RS 130 by tunneling in step 717.

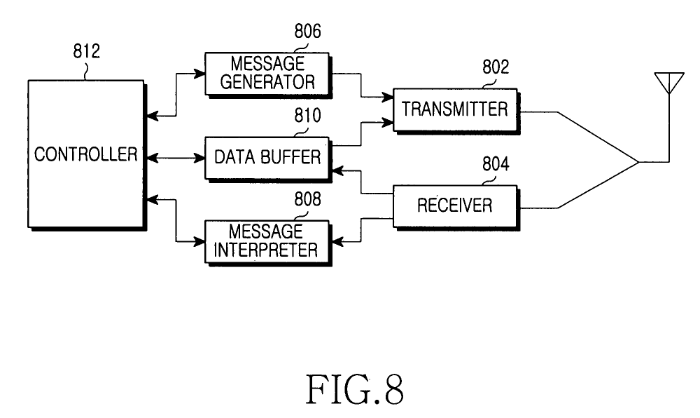

FIG. 8 is a block diagram of a base station (BS) in the multi-hop wireless communication system according to the present invention.

Referring to FIG. 8, the base station includes a transmitter 802, a receiver 804, a message generator 806, a message interpreter 808, a data buffer 810, and a controller 812.

The transmitter 802 converts an information bit stream to a radio frequency (RF) signal prior to transmission. If the transmitter 802 operates in Orthogonal Frequency Division Multiplexing (OFDM), it encodes the information bit stream and modulates the coded bit stream to complex symbols. The transmitter 802 maps the complex symbols to subcarriers and generates OFDM symbols using the mapped symbols by Inverse Fast Fourier Transform (IFFT). After upconverting the OFDM symbols to an RF signal, the transmitter 802 transmits the RF signal through an antenna.

The receiver 804 converts a received RF signal to an information bit stream. When the receiver 804 operates in OFDM, it downconverts an RF signal received through the antenna, divides the downconverted signal into OFDM symbols, and acquires complex symbols mapped to subcarriers from the OFDM symbols by Fast Fourier Transform (FFT). The receiver 804 demodulates the complex symbols to a coded bit stream and recovers the information bit stream by decoding the coded bit stream.

The message generator 806 generates control messages for controlling radio connections of mobile stations. Especially for handover of a mobile station (MS), the message generator 806 generates an HO-NOTIFY message, an HO-NOTIFY-ACK message, an HO-REPORT message, an HO-RSP message, and an HO-COMPLETE message according to the present invention. That is, the message generator 806 generates the above messages using information received from the controller 812 according to their formats.

The message interpreter 808 interprets control messages for controlling the radio connections of the MSs. Especially for handover of the MS, the message interpreter 808 interprets an HO-REQ message, an HO-NOTIFY message, an HO-NOTIFY-ACK message, and an HO-COMPLETE message according to the present invention. That is, the message interpreter 808 extracts from the above received messages according to their formats and provides the information to the controller 812.

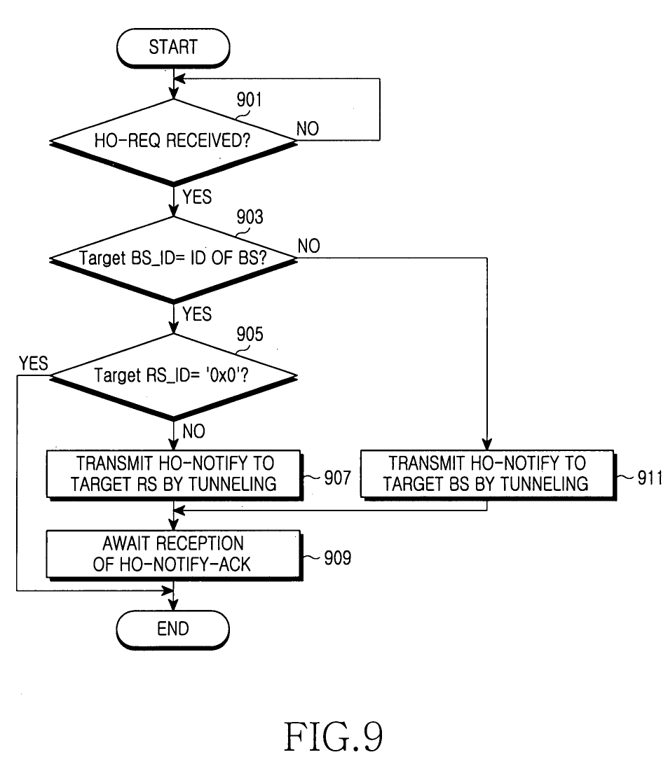

The data buffer 810 temporarily stores traffic data transmitted to, or received from, the mobile stations. The controller 812 controls the operations of the transmitter 802, the receiver 804, the message generator 806, the message interpreter 808, and the data buffer 810. Especially, the controller 812 controls the operation of the BS according to the handover procedures illustrated in FIGS. 3 to 7 according to the present invention. That is, the controller 812 perform control operations according to the control messages illustrated in FIGS. 2A to 2I. The control operations based on the control messages will be described below in detail with reference to FIGS. 9 to 13.

FIG. 9 is a flowchart of an operation of the base station (BS) when the BS receives an HO-REQ message in the multi-hop wireless communication system according to the present invention. The BS is a serving BS that can be one of BS1, BS2 and the RS 130.

Referring to FIG. 9, the BS monitors reception of an HO-REQ message from a mobile station (MS) in communication with the BS in step 901.

Upon receipt of the HO-REQ message, the BS determines whether its ID is set in Target BS_ID of the HO-REQ message in step 903.

If the ID of the BS is not set in Target BS_ID, the BS generates an HO-NOTIFY message and transmits the HO-NOTIFY message to a BS indicated by Target BS_ID in step 911.

If Target BS_ID indicates the ID of the BS, the BS checks whether Target RS_ID is set to ‘0x0’ in the HO-REQ message in step 905. That is, the BS determines whether a target node is its lower RS. If Target RS_ID is set to ‘0x0’, the HO-REQ message is an error. Hence, the BS ends the procedure of the present invention.

If Target RS_ID is not ‘0x0’, which implies that the target node is a lower RS under the BS, the BS generates an HO-NOTIFY message and transmits the HO-NOTIFY message to the RS indicated by Target RS_ID in step 907.

In step 909, the BS awaits reception of an HO-NOTIFY-ACK message.

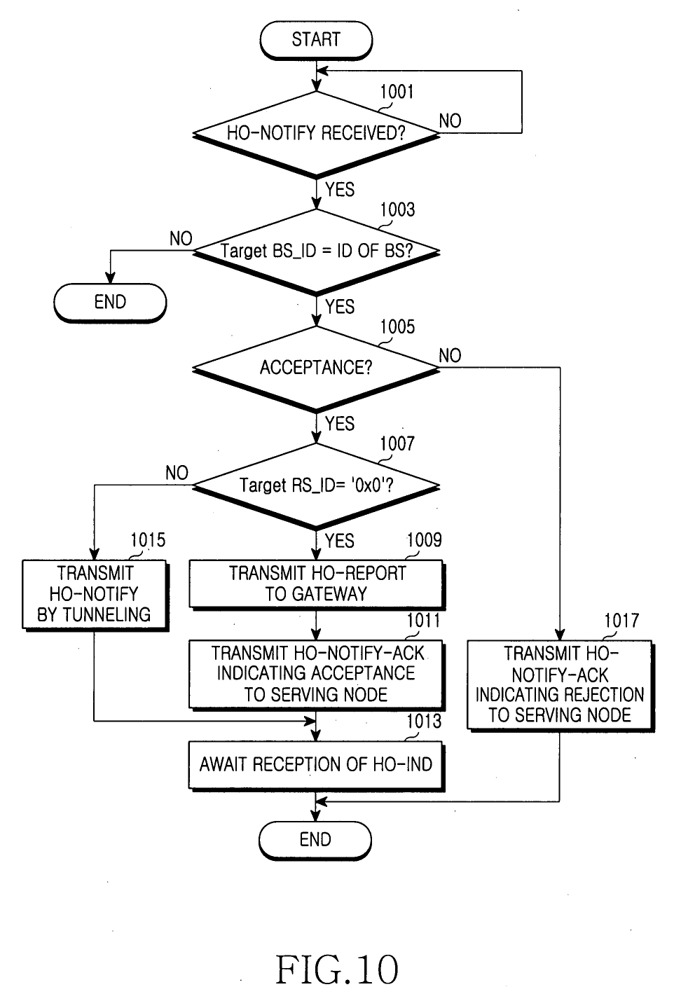

FIG. 10 is a flowchart of an operation of the base station (BS) when the BS receives an HO-NOTIFY message in the multi-hop wireless communication system according to the present invention. The BS is a target BS that can be one of BS1, BS2, and the RS 130.

Referring to FIG. 10, the BS monitors reception of an HO-NOTIFY message from a neighbor BS or a lower RS in step 1001.

Upon receipt of the HO-NOTIFY message, the BS checks whether Target BS_ID is set to the ID of the BS in the message in step 1003. If the ID of the BS is not set in Target BS_ID, the BS ends the procedure of the present invention.

If Target BS_ID is set to the ID of the BS, the BS determines whether it can accept the handover of the MS, taking account resource status and other factors in step 1005.

If the BS cannot accept the handover of the MS, it generates an HO-NOTIFY-ACK message indicating rejection and transmits the HO-NOTIFY-ACK message to the BS that transmitted the HO-NOTIFY message in step 1017.

If the BS can accept the handover of the MS, it checks whether Target RS_ID is ‘0x0’ in the HO-NOTIFY message in step 1007. That is, the BS determines whether the target node is an RS under the BS.

If Target RS_ID is not ‘0x0’, the BS transmits the HO-NOTIFY message to the RS indicated by Target RS_ID by tunneling in step 1015.

If Target RS_ID is ‘0x0’, the BS generates an HO-NOTIFY-ACK message indicating acceptance and transmits the HO-NOTIFY-ACK message to the BS that transmitted the HO-NOTIFY message in step 1011.

In step 1013, the BS awaits reception of an HO-IND message.

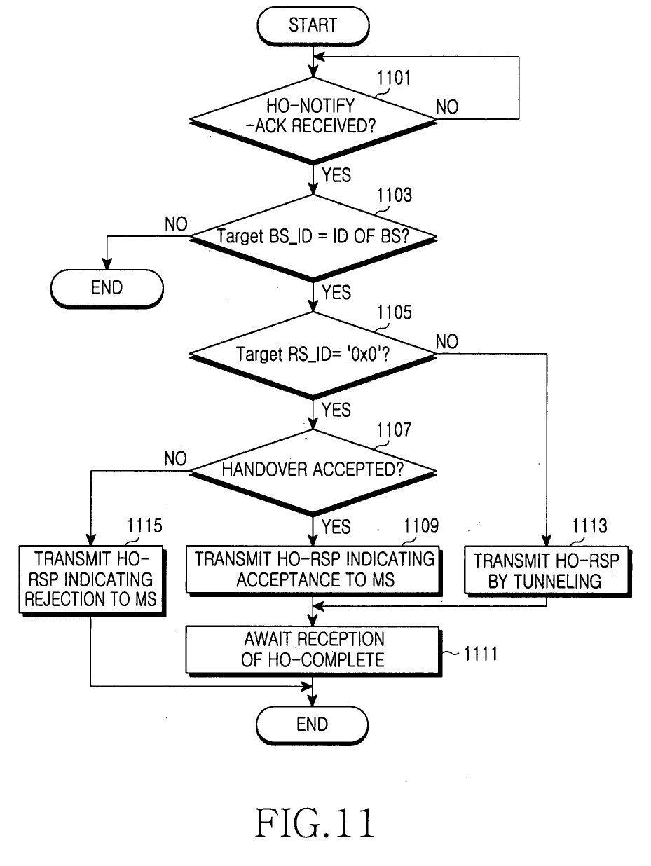

FIG. 11 is a flowchart of an operation of the base station (BS) when the BS receives an HO-NOTIFY-ACK message in the multi-hop wireless communication system according to the present invention. The BS is a serving BS that can be one of BS1, BS2, and the RS 130.

Referring to FIG. 11, the BS monitors reception of an HO-NOTIFY-ACK message from a neighbor BS or a lower RS that has received an HO-NOTIFY message in step 1101.

Upon receipt of the HO-NOTIFY-ACK message, the BS checks whether Target BS_ID is set to the ID of the BS in the message in step 1103. If the ID of the BS is not set in Target BS_ID, the BS ends the procedure of the present invention.

If Target BS_ID is set to the ID of the BS, the BS determines whether Target RS_ID is ‘0x0’ in the HO-NOTIFY-ACK message in step 1105. That is, the BS determines whether the serving node is an RS under the BS.

If Target RS_ID is not ‘0x0’, the BS transmits the HO-NOTIFY-ACK message to the RS indicated by Target RS_ID by tunneling in step 1113. If Target RS_ID is ‘0x0’, the BS checks whether the HO-NOTIFY-ACK message indicates handover acceptance in step 1107.

If the handover has been rejected, the BS generates an HO-RSP message indicating rejection and transmits the HO-RSP message to the MS in step 1115.

If the handover has been accepted, the BS generates an HO-RSP message indicating acceptance and transmits the HO-RSP message to the MS in step 1109. In step 1111, the BS awaits reception of an HO-COMPLETE message.

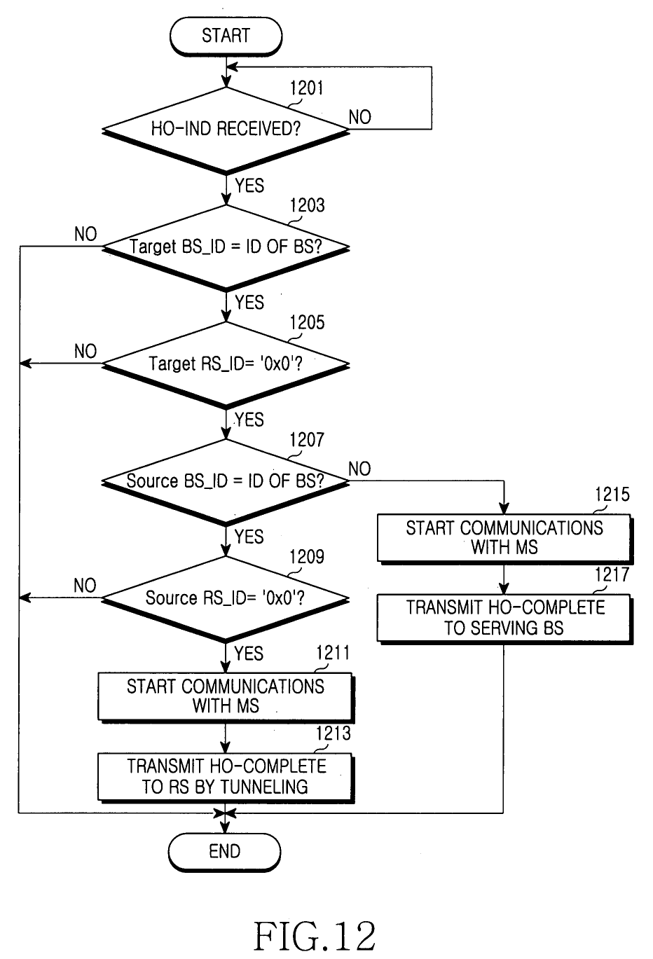

FIG. 12 is a flowchart of an operation of the base station (BS) when the BS receives an HO-IND message in the multi-hop wireless communication system according to the present invention. The BS is a target BS that can be one of BS1, BS2, and the RS 130.

Referring to FIG. 12, the BS monitors reception of an HO-IND message from an MS that will move to the BS by handover in step 1201.

Upon receipt of the HO-IND message, the BS checks whether Target BS_ID is set to the ID of the BS in the message in step 1203. If the ID of the BS is not set in Target BS_ID, the BS ends the procedure of the present invention.

If Target BS_ID is set to the ID of the BS, the BS checks whether Target RS_ID is ‘0x0’ in the HO-IND message in step 1205. That is, the BS determines whether the target node is an RS under the BS.

If Target RS_ID is not ‘0x0’, the BS ends the procedure of the present invention. If Target RS_ID is ‘0x0’, the BS checks whether Source BS_ID is the ID of the BS in the HO-IND message in step 1207.

If Source BS_ID is not set to the ID of the BS, the BS starts to communicate with the MS that transmitted the HO-IND message in step 1215. In step 1217, the BS generates an HO-COMPLETE message and transmits it to a BS indicated by Source BS_ID in step 1217.

If Source BS_ID is set to the ID of the BS, the BS checks whether Source RS_ID is ‘0x0’ in the HO-IND message in step 1209. If Source RS_ID is ‘0x0’, the BS ends the procedure of the present invention.

If Source RS_ID is not ‘0x0’, the BS starts to communicate with the MS that transmitted the HO-IND message in step 1211. Since the handover of the MS is from the lower RS to the BS within the same cell, the BS changes a transmission mode for the MS from DR mode to DT mode. In step 1213, the BS generates an HO-COMPLETE message and transmits it to the RS indicated by Source RS_ID by tunneling.

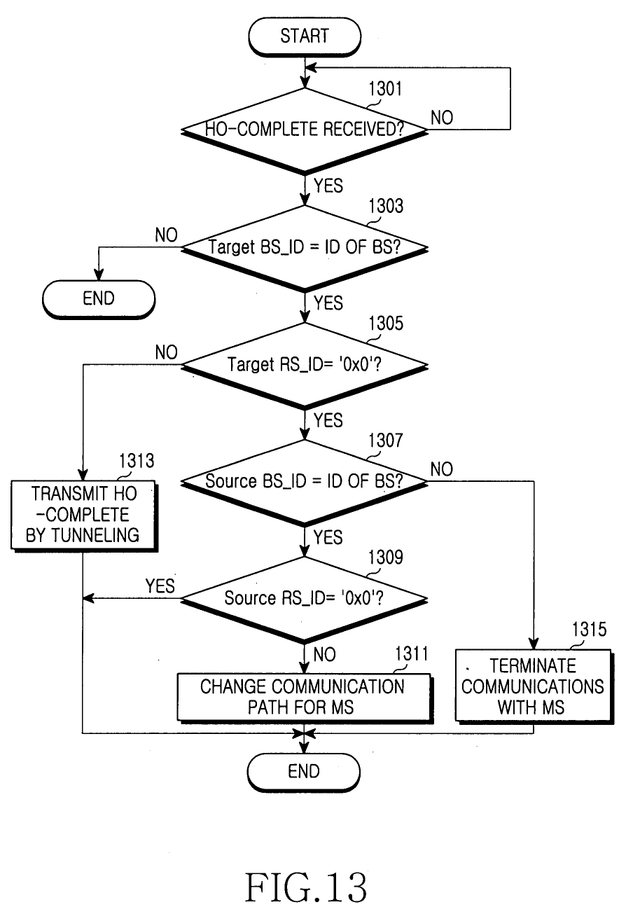

FIG. 13 is a flowchart of an operation of the base station (BS) when the BS receives an HO-COMPLETE message in the multi-hop wireless communication system according to the present invention. The BS is a serving BS that can be one of BS1, BS2, and the RS 130.

Referring to FIG. 13, the BS monitors reception of an HO-COMPLETE message from a target BS that an MS has moved to by handover in step 1301.

Upon receipt of the HO-COMPLETE message, the BS checks whether Target BS_ID is set to the ID of the BS in the message in step 1303. If the ID of the BS is not set in Target BS_ID, the BS ends the procedure of the present invention.

If Target BS_ID is set to the ID of the BS, the BS checks whether Target RS_ID is ‘0x0’ in the HO-COMPLETE message in step 1305. That is, the BS determines whether the target node is an RS under the BS.

If Target RS_ID is not ‘0x0’, the BS transmits the HO-COMPLETE message to the RS indicated by Target RS_ID in step 1313. If Target RS_ID is ‘0x0’, the BS checks whether Source BS_ID is the ID of the BS in the HO-COMPLETE message in step 1307.

If Source BS_ID is not set to the ID of the BS, the BS ends communications with the MS in step 1315. If Source BS_ID is set to the ID of the BS, the BS checks whether Source RS_ID is ‘0x0’ in the HO-COMPLETE message in step 1309. If Source RS_ID is ‘0x0’, the BS ends the procedure of the present invention.

If Source RS_ID is not ‘0x0’, the BS changes the communication path of the MS in step 1311. That is, since the MS has performed a handover from the BS to the RS within the same cell, the BS changes the transmission mode for the MS from DT mode to DF mode.

As is apparent from the above description, the present invention advantageously ensures stable QoS for an MS by providing handover procedures according to movement of the MS in which the MS decides on a handover and selects a target BS, and specific operations of a BS in the handover procedures in a multi-hop wireless communication system.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A handover method of a serving base station in a multi-hop wireless communication system, comprising:
transmitting upon receipt of a handover request message requesting a handover from a mobile station, a handover notify message to a target base station indicated by the handover request message;
receiving a handover notify acknowledgment (ACK) message from the target base station and determining from the handover notify ACK message whether the target base station has accepted the handover of the mobile station;
generating a handover response message indicating whether the handover of the mobile station has been accepted and transmitting the handover response message to the mobile station; and
terminating communications with the mobile station, upon receipt of a handover complete message from the target base station.

2. The handover method of claim 1, wherein the handover request message includes at least one of a message type, a mobile station identification (MS ID), a source identification (ID), and a target identification (ID), the message type identifying the handover request message, the MS ID identifying the mobile station that transmits the handover request message, the source ID identifying the serving base station to which the mobile station is currently connected, and the target ID identifying the target base station to which the mobile station performs the handover.

3. The handover method of claim 2, wherein the source ID is a combination of a serving relay station identification (RS ID) and a serving base station identification (BS ID), and the target ID is a combination of a target relay station identification (RS ID) and a target base station identification (BS ID).

4. The handover method of claim 3, wherein the handover notify message transmission comprises transmitting the handover notify message to a relay station indicated by the target RS ID by tunneling, if the target base station ID is set to an identification of the serving base station and the target RS ID is not ‘0x0’ in the handover request message.

5. The handover method of claim 3, wherein the handover notify message transmission comprises transmitting the handover notify message to a neighbor base station indicated by the target BS ID, if the target BS ID is not set to an identification of the serving base station in the handover request message.

6. The handover method of claim 1, wherein the handover notify ACK message includes at least one of a message type, a mobile station identification (MS ID), a source identification (ID), a target identification (ID), and a confirmation code, the message type identifying the handover notify ACK message, the MS ID identifying the mobile station that performs the handover, the source ID identifying the target base station to which the mobile station performs the handover, the target ID identifying the serving base station to which the mobile station is currently connected, and the confirmation code indicating whether the handover has been accepted.

7. The handover method of claim 6, wherein the source ID is a combination of a serving relay station identification (RS ID) and a serving base station identification (BS ID), and the target ID is a combination of a target relay station identification (RS ID) and a target base station identification (BS ID).

8. The handover method of claim 7, wherein the handover response message transmission comprises transmitting the handover response message to the mobile station, if the target base station ID is set to an ID of the serving base station and the target RS ID is ‘0x0’ in the handover notify ACK message.

9. The handover method of claim 8, further comprising a waiting reception of the handover complete message after transmitting the handover response message, if the handover has been accepted.

10. A handover method of a target base station in a multi-hop wireless communication system, comprising:
receiving a handover notify message indicating a mobile station will perform a handover from a serving base station;
determining whether a target base station identification (BS ID) is set to an identification (ID) of the target base station in the handover notify message;
determining whether to accept the mobile station, if the target BS ID is set to the identification of the target base station in the handover notify message;
determining whether a target relay station identification (RS ID) indicates a relay station under the target base station, if it is determined to accept the mobile station;
transmitting the handover notify message to the relay station by tunneling, if the target RS ID indicates an relay station under the target base station;
receiving from the mobile station a handover indication message indicating that the mobile station will perform the handover; and
transmitting a handover complete message to the serving base station by tunneling.

11. The handover method of claim 10, further comprising terminating a handover procedure, if the target BS ID is not set to the identification of the target base station in the handover notify message.

12. The handover method of claim 10, further comprising:
receiving a handover notify ACKnowledgment (ACK) message from the relay station by tunneling; and
transmitting the handover notify ACK message to the serving base station.

13. The handover method of claim 10, further comprising:
generating a handover notify ACK message indicating that the handover of the mobile station has been accepted, if the target RS ID does not indicate a relay station under the target base station; and
transmitting the handover notify ACK message to the serving base station.

14. The handover method of claim 10, further comprising:
generating a handover notify ACK message indicating that the handover of the mobile station has been rejected, if it is determined to reject the mobile station; and
transmitting the handover notify ACK message to the serving base station.

15. The handover method of claim 10, wherein the determination as to whether a target RS ID indicates a relay station under the target base station comprises determining that the target RS ID indicates a relay station under the target base station, if the target RS ID is not ‘0x0’ in the handover notify message.

16. The handover method of claim 10, wherein the handover notify message includes at least one of a message type, a mobile station identification (MS ID), a source identification (ID), a target identification (ID), a service identification (ID), and a Modulation and Coding Scheme (MCS) level, the message type identifying the handover notify message, the MS ID identifying the mobile station that performs the handover, the source ID identifying the serving base station to which the mobile station is currently connected, the target ID identifying the target base station to which the mobile station performs the handover, the service ID identifying a service that the mobile station is receiving, and the MCS level indicating an MCS applied to the mobile station.

17. The handover method of claim 15, wherein the source ID is a combination of a serving relay station identification (RS ID) and a serving base station identification (BS ID), and the target ID is a combination of a target relay station identification (RS ID) and a target base station identification (BS ID).

18. The handover method of claim 10, wherein the handover indication message includes at least one of a message type, an mobile station identification (MS ID), a source identification (ID), and a target identification (ID), the message type identifying the handover indication message, the MS ID identifying the mobile station that transmits the handover indication message, the source ID identifying the serving base station to which the mobile station is currently connected, the target ID identifying the target base station to which the mobile station performs the handover.

19. The handover method of claim 12, further comprising transmitting a handover report message to a gateway, after transmitting the handover notify ACK message to the serving base station.

20. The handover method of claim 13, further comprising transmitting a handover report message to a gateway, before transmitting the handover notify ACK message to the serving base station.
